(19) United States
(12) Patent Application Publication
(10) Pub. No.: US 2023/0054086 A1
(43) Pub. Date: Feb. 23, 2023

(54) Wheel Cover

(71) Applicant: Ian Fletcher, Northcliff (ZA)

(72) Inventor: Ian Fletcher, Northcliff (ZA)

(21) Appl. No.: 17/796,885

(22) PCT Filed: Jan. 21, 2021
(86) PCT No.: PCT/ZA2021/050003

§ 371 Date: Aug. 2, 2022

(30) Foreign Application Priority Data
Feb. 10, 2020 (ZA) 2020/00821

(51) Int. Cl. B60B 7/00; B60B 7/06; B60B 7/04; B60B 7/20; B60B 7/08; B60Q 1/50; G09F 21/04; G09F 9/30; G09F 13/00

(52) U.S. Cl. CPC B60B 7/006; B60B 7/063; B60B 7/04; B60B 7/0053; B60B 7/20; B60B 7/08; B60Q 1/5035; G09F 21/045; G09F 9/30; G09F 13/00; B60B 2900/572; B60B 2900/212; B60R 16/03

(57) ABSTRACT

THIS invention relates to a wheel cover. More specifically, the invention relates to an advertising wheel cover having a wheel mount for push fitting into a vehicle wheel rim and a display disc rotatably mounted to the wheel mount by bayonet-type connectors. The display disc is off-centre weighted so as to remain in a substantially upright and static orientation relative to the wheel mount, which is rotatable with the wheel.

### BACKGROUND OF THE INVENTION

THIS invention relates to a wheel cover. More specifically, the invention relates to an advertising wheel cover having a wheel mount for push fitting into a vehicle wheel rim and a display disc rotatably mounted to the wheel mount by bayonet-type connectors. The display disc is off-centre weighted so as to remain in a substantially upright and static orientation relative to the wheel mount, which is rotatable with the wheel.

Advertising devices mountable on vehicle wheels are well known. Some fix a display panel directly to the wheel. Consequentially, the advert on the display panel is rotatable with the wheel and such, not always presented to onlookers in a substantially upright and readable orientation.

Others have attempted to address the disadvantage of the direct-fix display panel devices by rotatably mounting an off-centre weighted display panel to the wheel indirectly via an intermediary mount. Although these rotatable-mounted display panel devices largely solve the problem of retaining the advertisement in an upright position, they have been found lacking in other areas.

The securement of the display panels is one problematic area. Some of these rotatable-mounted display panel devices have display panels that are not removable and accordingly, not easily interchangeable to change out advertisements. Others have display panels that are too easily removable (i.e. rear foldable tabs) making them vulnerable to theft or loss.

The fixing of the intermediary mount to the vehicle wheel is another problematic area in these rotatable-mounted display panel devices. Some require the intermediary mount to be secured to the hub of the wheel by modified lug bolts. Others have attempted to rim-mount the intermediary mount to the vehicle wheel, but are largely incapable of limiting access rearward of the display panel to minimise unauthorised decoupling of the display panel from the intermediary mount.

It is an object of the present invention to provide an advertising wheel cover that address the drawbacks of the known prior art.

### SUMMARY OF THE INVENTION

According to the invention there is provided a wheel cover for a wheel including:

a wheel mount comprising:

an annular body having a base end, an opposing open end and one or more gripping formations on an outer radial face thereof for frictionally engaging a radially inner surface of a wheel rim of the wheel thereby to operative enable quick-release, push fit mounting of the wheel mount onto the wheel rim;

a base plate, integral with or connectable to the annular body, located axially at or near the base end of the annular body; and

a first connector mounted on the base plate and extending axially outwardly thereof toward the open end of the annular body;

a display disc having:

a first face adapted for displaying branding, decorative or advertising indicia thereon;

a second opposing face;

a second connector mounted on and extending axially from the second face of the display disc; and

a weight spaced radially from the display disc's centre;

wherein either: (i) the first connector is rotatably mounted to the base plate; (ii) the second connector is rotatably mounted to the display disc; or (iii) both; thereby to enable relative rotation between the display disc and the wheel mount;

characterised in that the connectors are bayonet-type or threaded connectors, with the first connector being a male or a female bayonet-type or threaded connector, and the second connector being the other of the male or the female bayonet-type or threaded connector.

The annular body may be substantially cylindrical or substantially bowl-shaped and, where substantially bowl-shaped, the annular body curves, tapers and/or steps radially inwardly from the open end of the annular body towards the base end thereof.

Generally, the outer radial face of the annular body is frictionally engageable with the wheel rim directly. Alternatively, the annular body supports one or more resilient mounting clips that radially engage the wheel rim.

Typically, the annular body comprises a lip running about the open end of the annular body, which lip defines an opening into the annular body. The annular body may be sized and shaped to operatively locate the lip, with the wheel mount push fit onto the wheel rim, proximate the wheel's tyre bead. In the event of tyre deflation, the wheel cover is pushed free of the wheel rim through contact between the deflated tyre and the annular body thereby to minimise damage to the wheel cover, wheel rim or tyre.

Preferably, the annular body defines a tool notch located along the lip thereof for accommodating there-through, and limiting the angular displacement of, a custom tool for locking at least one of the connectors against rotation during coupling and decoupling of such connectors. More preferably, the annular body defines a primary valve notch for accommodating a valve of the wheel to which the wheel mount is operatively mounted.

The base plate may be disc shaped and connected to the annular body by a plurality of fasteners passing through the base plate and into mounting formations located about the annular body, at or near the base end thereof.

In one embodiment, the second connector may be rotatably mounted to the display disc on a bearing. In a preferred embodiment, the second connector may be fixed on the display disc, with the base plate comprising a mounting post extending axially outwardly from the base plate of the wheel mount toward the open end thereof.

Generally, the first connector is rotatable on the mounting post about a rotary axis passing concentrically through the base plate, the mounting post, the first connector, the second connector and the display disc, with the first connector being rotatably mountable on the mounting post via a bearing.

Typically, the mounting post is integral with the base plate, or mountable thereon via a mounting bore defined centrally on the base plate. Furthermore, the base plate may define a secondary valve notch, being alignable with the primary valve notch of the annular body, to co-operatively accommodate the wheel valve therein.

Preferably, the mounting post is a bolt comprising, from a head-end thereof: the bearing, a cylindrical spacer about which the first connector is receivable; and a nut for engaging a threaded end of the bolt passing through the mounting bore thereby to fasten the mounting post on the base plate.

The cylindrical spacer acts as a bush on which the first connector has limited axial movement along, with one end of the spacer tightened against an axial face of an inner race of the bearing and an opposite end thereof tightened against the base plate.

More preferably, the first connector is the female bayonet-type connector having a socket formation defining a plurality of substantially L-shaped or J-shaped connecting slots. Most preferably, the second connector is the male bayonet-type connector having a connecting post with a plurality of pins extending radially outwardly therefrom, with the pins being sized and shaped to ride along the connecting slots. As such, the male bayonet-type connector is connectable to or disconnectable from the female bayonet-type connector through a relative axial and twist motion.

Alternatively, where the connectors are threaded connectors instead of bayonet-type connectors, the first connector is generally the female threaded connector having a socket formation defining an internal thread winding along an inner radial face of the socket formation, while the second connector is typically the male threaded connector having a connecting post with an external thread winding along an outer radial face of the connecting post.

In a coupled condition, axial inner faces of the first and second connectors abut against respective opposing axial faces of an outer race of the bearing such that rotational forces are transmittable there-between by friction forces acting at the abutting faces. To further enhance the friction forces acting at the abutting faces, the wheel cover may comprise first and second rubber washers, the first rubber washer being sandwiched between the first connector and one of the axial faces of the outer race of the bearing, with the second rubber washer being sandwiched between the second connector and the opposite axial face of the outer race of the bearing.

The display disc is generally sized and shaped substantially the same as the opening defined by the lip of the annular body. Furthermore, the display disc is preferably mountable axially proximate such lip thereby to restrict access to components stored there-behind, and to the connectors other than by using the custom tool.

Typically, the custom tool is sized and shaped to pass through the tool notch defined in the lip of the annular body, and to engage a locking formation on the first connector to operably lock the first connector against rotation about the rotary axis during the coupling and/or decoupling of the second connector and consequentially the display disc from the first connector.

Preferably, the custom tool is elongate having a first handle end and a second forked end, with the second forked end comprising a pair of prongs having inner faces spaced from one another sufficiently to accommodate the mounting post, as well as outer faces adapted to engage the locking formation on the first connector.

Generally, the custom tool is stepped and/or substantially Z-shaped, having a rounded and/or tapering handle end adapted for operatively leveraging between the wheel rim and the wheel mount to comprise the wheel cover from the wheel.

Typically, the wheel cover includes a means for visually orientating the display disc with the wheel mount thereby to consequentially align the locking formation of the first connector with the tool notch defined on the wheel mount.

Preferably, a width dimension of the tool notch is slightly greater than a width dimension of the custom tool so as to enable the custom tool to operatively pass there-through to engage the locking formation of the first connector. Furthermore, the relative width dimension operably limits rotation of the custom tool and consequentially the first connector through abutment of the custom tool with the tool notch ends for enabling coupling and/or decoupling of the display disc from the first connector. Generally, the width dimension of the custom tool is between 10% and 50% greater than the width dimension of the custom tool.

In another embodiment, the display disc may comprise an electronic screen for displaying the branding, decorative or advertising indicia thereon. In yet a further embodiment, the display disc may also comprise lighting thereon to further draw the attention of an onlooker to the branding, decorative or advertising indicia displayed on the display disc.

The electronic screen and/or lighting may be powered by an independent power source at least partially located on the wheel cover, with the independent power source and accompanying electronics being mountable on the display disc to double up as the weight.

Alternatively, the electronic screen and/or lighting may be powered by the power source of a vehicle to which wheels the wheel cover is operatively mounted. The power may be transmittable between the vehicle and the wheel cover by a conductor or via induction.

Furthermore, the electronic screen and/or lighting may be programmable via hardwire or a wireless communications module.

Generally, the display disc comprises secondary counter-weights to balance the display disc thereby to restrict wobble.

### BRIEF DESCRIPTION OF THE INVENTION

The invention will now be described in more detail, by way of example only, with reference to the accompanying illustrations, in which:

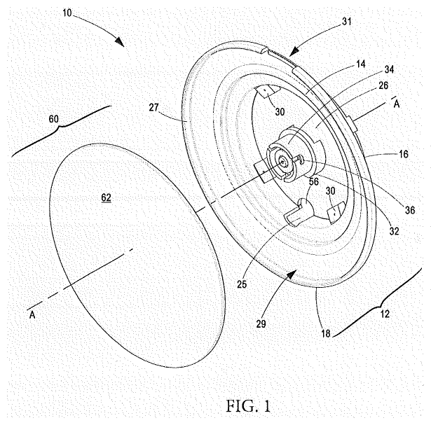

FIG. 1 is a first perspective view of a wheel cover in accordance with the present invention, having a display disc thereof in a decoupled configuration relative to a wheel mount thereof;

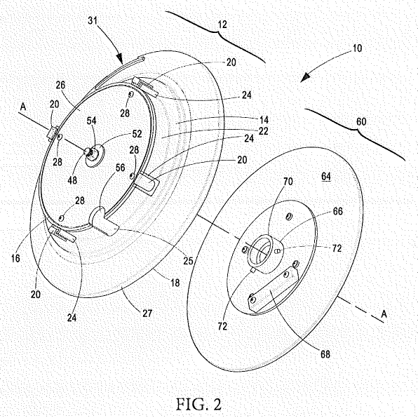

FIG. 2 is a second perspective view of the wheel cover of FIG. 1;

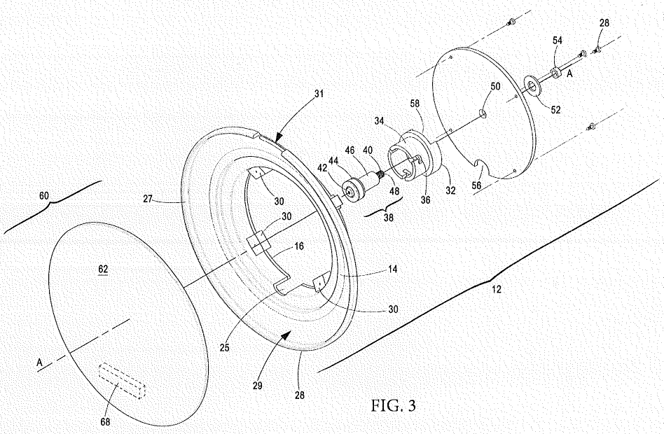

FIG. 3 is a first exploded perspective view of the wheel cover of FIG. 1;

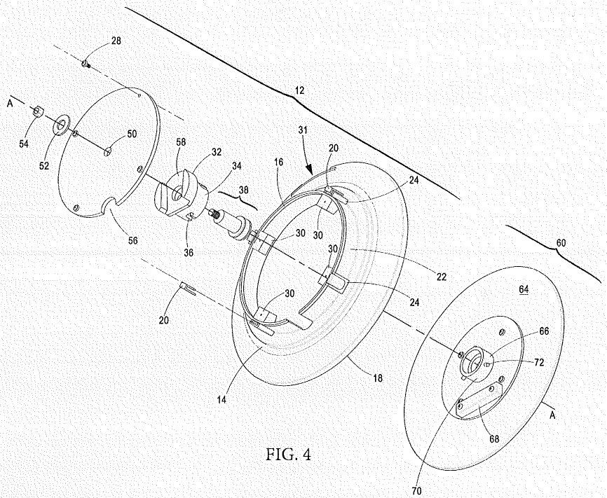

FIG. 4 is a second exploded perspective view of the wheel cover of FIG. 1;

FIG. 5 is a third perspective view of the wheel cover of FIG. 1 prior to mounting to a wheel;

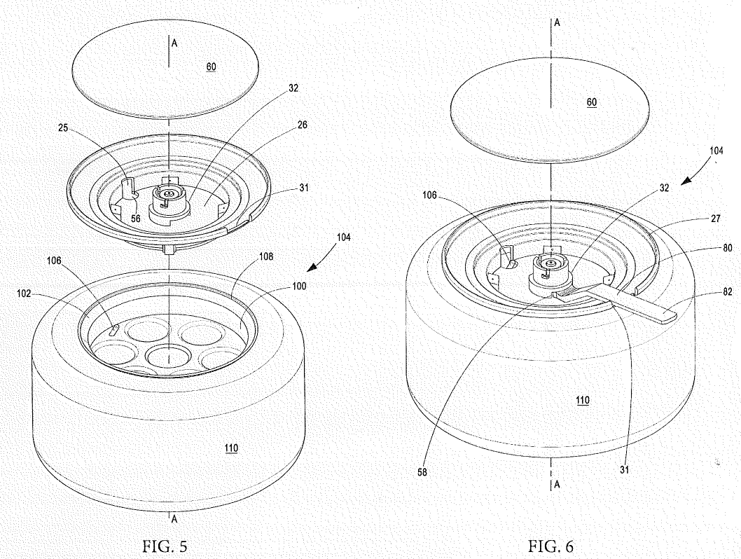

FIG. 6 is a fourth perspective view of the wheel cover of FIG. 1 with the wheel mount thereof mount to the wheel;

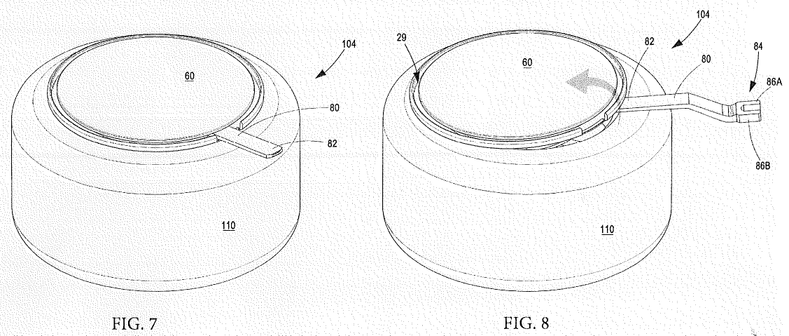

FIG. 7 is a fifth perspective view of the wheel cover of FIG. 6 with the wheel mount thereof mount to the wheel, and having the display disc thereof in a coupled configuration relative to the wheel mount;

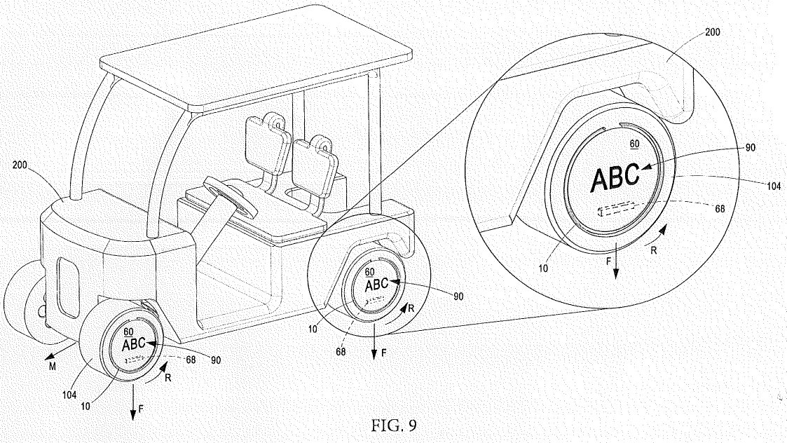

FIG. 8 is a sixth perspective view of the wheel cover of FIG. 7 being removed from the wheel; and

FIG. 9 is a seventh perspective view of the wheel cover as applied to a golf cart vehicle.

### DETAILED DESCRIPTION OF THE INVENTION

A wheel cover according to a preferred embodiment of the invention is designated generally in the accompanying Figures by reference numeral 10. With reference to FIG. 1 and FIG. 2, the wheel cover 10 comprises a wheel mount 12 and a display disc 60 rotatably mountable thereon.

With reference now also to FIG. 3 and FIG. 4, the wheel mount 12 comprising an annular body 14 having a base end 16, an opposing open end 18 and one or more gripping formations 20 located on an outer radial face 22 thereof for frictionally engaging a radially inner surface 100 of a wheel rim 102 of a vehicle wheel 104, as illustrated in FIG. 5.

Although the gripping formations 20 have been illustrated in the accompanying Figures as resilient mounting clips located about the outer radial face 22 of the annular body 14 by clip mounts 24 so as to enable quick-release, push fit mounting of the wheel mount 12 onto the wheel rim 102, it will be appreciated that the gripping formations 20 may take different forms. For example, the annular body 14 may be inherently resilient enough, or have castellated portions that are inherently resilient enough, to frictionally engage with the wheel rim 102 directly.

The wheel mount 12 further comprises a disc-shaped base plate 26 connectable to the annular body 14 by a plurality of fasteners 28 passing through the base plate 26 and into mounting formations 30 located about the annular body 15, at or near the base end 16 thereof. It will be appreciated that to fit within the contour of the wheel rim 102, the annular body 14 with the base plate 26 mounted thereon is substantially bowl-shaped, curving, tapering and stepping radially inwardly from the open end 18 of the annular body towards the base end 16 thereof.

Furthermore, the annular body 14 comprises a primary valve notch 25 for at least partially accommodating a wheel valve 106 and a lip 27 running about the open end 18 thereof. The lip 27 defines an opening 29 into the annular body 14 and a tool notch 31, which will be described in more detail later in this description.

The annular body 14 is sized and shaped to operatively locate the lip 27, with the wheel mount 12 push fit onto the wheel rim 102, proximate the wheel's tyre bead 108. In the event of tyre 110 deflation, the wheel cover 12 is pushed free of the wheel rim 102 through contact between the deflated tyre and the annular body 14 thereby to minimise damage to the wheel cover 12, wheel rim 102 or tyre 110.

The wheel mount 12 also comprises a first connector 32 in the form of a female bayonet connector having a socket formation 34 defining thereon a plurality, preferably three, substantially J-shaped connecting slots 36. The first connector 32 is rotatably mountable to the base plate 26 by a mounting post 38 extending axially outwardly from the base plate 26 along a rotary axis A-A passing concentrically through the wheel cover 10, about which the first connector 32 is rotatable relative to the annular body 14 and base plate 26.

The mounting post 38 is in the form of bolt 40 having sequentially mounted thereon ,from a head-end 42 thereof along its shank, a bearing 44 on which the first connector 32 is rotatable and a cylindrical spacer 46 about which the first connector 32 is receivable.

As can best be seen in FIG. 3 and FIG. 4, the cylindrical spacer 46 acts as a bush on which the first connector has limited axial movement along, with one end of the spacer 46 being tightened against an axial face of an inner race of the bearing 44 and an opposite end thereof tightened against the base plate 26.

With the first connector 32 located on the mounting post 38, a free end 48 thereof is passed through a mounting bore 50 defined centrally on the base plate 26, and fastened there-onto by a washer 52 and nut 54. The base plate 26 further defines a secondary valve notch 56, being alignable with the primary valve notch 25 of the annular body 14, to co-operatively accommodate the wheel valve 106 therein.

The display disc 60 comprises a first face 62 adapted for displaying branding, decorative or advertising indicia thereon, a second opposing face 64, a second connector 66 fixed on and extending axially outwardly from the second face 64 of the display disc 60 and a weight 68 spaced radially from and off-centre from the centre of the display disc 60.

The second connector 66 is a male bayonet connector having a connecting post 70 with a plurality of pins 72, preferably three, extending radially outwardly therefrom. The pins 72 are sized and shaped to ride along the connecting slots 36, under and axial-twist motion imparted thereon, for coupling and decoupling the first and second bayonet-type connectors 32, 66.

It will be appreciated that when coupled, axial inner faces of the first and second connectors 32, 66 abut against respective opposing axial faces of an outer race of the bearing 44 such that rotational forces are transmittable there-between by friction forces acting at such abutting faces. To further enhance the friction forces acting at the abutting faces, the wheel cover 10 may comprise first and second rubber washers, with the first rubber washer being sandwiched between the first connector 32 and one of the axial faces of the outer race of the bearing 44, with the second washer being sandwiched between the second connector 66 and the opposite axial face of the outer race of the bearing 44.

The display disc 60 is sized and shaped substantially the same as the opening 29 defined by the lip 27 of the annular body 14, and mountable axially proximate such lip 27, as illustrated best in FIG. 7 thereby to restrict access to components stored there-behind, and to the connectors 32, 66 other than by using a custom tool 80.

The custom tool 80 is sized and shaped to pass through the tool notch 31 defined in the lip 27 of the annular body 14 to engage a locking formation 58 defined on the first connector 32. With the custom tool 80 engaged in the locking formation 58, as illustrated in FIG. 6, FIG. 7 and FIG. 8, and with the angular displacement of the custom tool being limited by opposing ends of the tool notch 31, the first connector 32 is locked against rotation about the rotary axis A-A, enabling the coupling and/or decoupling of the second connector 66, and consequentially the display disc 60, to the wheel mount 12.

With reference now also to FIG. 8, the custom tool 80 is elongate and substantially Z-shaped, including a first handle end 82 and a second forked end 84, which second forked end 84 comprises a pair of prongs 86A, 86B having inner faces spaced from one another sufficiently to accommodate the mounting post 38 there-between, as well as outer faces adapted to engage the locking formation 58 on the first connector 32.

Furthermore, the first handle end 82 of the custom tool 80 is rounded and/or tapered for operatively leveraging between the wheel rim 104 and the wheel mount 12, thereby to comprise the wheel cover 10 from the wheel rim 102 when required.

Typically, the wheel cover includes a means for visually orientating the display disc 60 with the wheel mount 12 thereby to consequentially align the locking formation 58 of the first connector 32 with the tool notch 31 defined on the wheel mount 12. Operatively, it is preferred that with the display disc 60 settle in position under the force of gravity, the tool notch 31, locking formation 58 and weight 68 are diametrically aligned across the wheel cover 10. In this manner, the custom tool 80 is easily engageable with the locking formation 58.

In use, and with reference to FIG. 9, it will be appreciated that under the force of gravity “F”, the weight 68 retains the display disc 60 and consequentially the indicia 90 displayed thereon in a substantially upright orientation and near static relative to the rotation “R” of the wheel 104 with the vehicle 200 moving in direction “M”.

It will be appreciated further that the wheel cover 10 of the present invention makes the unauthorised removal of the display disc 60 (i.e. other than with the custom tool 80) very difficult. Where the display disc 60 carries on-board components of significant value (i.e. lighting, electronic displays, electronics, batteries), this security feature is of utmost importance.

Simultaneously, authorised removal of the display disc 60 is very easy through the use of the custom tool 80. This enables the display disc 60 to be interchanged easily when advertising needs to be changed out. During change out, display discs 60 carrying new advertising material will replace the display discs 60 carrying old advertising material. In this manner, the display discs 60 are recyclable and capable of being outfitted with the new advertising material offsite from where the advertisements will be displayed.

Although the invention has been described with reference to a preferred embodiment, it will be appreciated that many modifications or variations of the invention are possible without departing from the spirit or scope of the invention.

For example, instead of the first connector being rotatably mounted on the base plate, the second connector may be rotatably on the display disc. Furthermore, the base plate may be integral with annular body. Even further, the mounting post may at least partially integral with the base plate.

Also, the male and female bayonet connectors may be swapped between the first and second connector, i.e. the first connector may be the male bayonet connector with the second connector being the female bayonet connector. Furthermore, the connectors could, instead of being bayonet-type connectors, be threaded connectors.

Where the display disc is outfitted with an electronic screen, the electronic screen is preferably programmable via hardwire or a wireless communication module.

Furthermore, where the display disc includes the electronic screen or attention drawings lighting, the electronics and independent power source thereof may be fitted on-board the display disc to double up at the weight.

Alternatively, the electronic screen and lighting may be powered by the power source of a vehicle to which the wheel cover is fitted, the power being transmittable between the vehicle and the wheel cover by a conductor or via induction.

The wheel cover may further comprise secondary counter-weights on the display disc to balance the display disc thereby to restrict wobble. Furthermore, the display disc and second connector may be integral or separate parts fastened together as illustrated in the accompanying Figure. Also, the second forked end of the custom tool may include a taper capable of wedging into the locking formation of the first connector not only to lock the first connector against rotation, but also to axially push the first connector slightly away from the base plate to assist during the decoupling of the connectors.

It will be appreciated that the simplicity of the design of the wheel cover in accordance with the present invention enables it to be manufactured from injection moulding processes, thereby to achieve a cost effective, light-weight product.

1. A wheel cover for a wheel including:
a wheel mount comprising:
an annular body having a base end, an opposing open end and one or more gripping formations on an outer radial face thereof for frictionally engaging a radially inner surface of a wheel rim of the wheel thereby to operative enable quick-release, push fit mounting of the wheel mount onto the wheel rim;
a base plate, integral with or connectable to the annular body, located axially at or near the base end of the annular body; and
a first connector mounted on the base plate and extending axially outwardly thereof toward the open end of the annular body;
a display disc having:
a first face adapted for displaying branding, decorative or advertising indicia thereon;
a second opposing face;
a second connector mounted on and extending axially from the second face of the display disc; and
a weight spaced radially from the display disc's centre;
wherein either: (i) the first connector is rotatably mounted to the base plate; (ii) the second connector is rotatably mounted to the display disc; or (iii) both; thereby to enable relative rotation between the display disc and the wheel mount;
characterised in that the connectors are bayonet-type or threaded connectors, with the first connector being a male or a female bayonet-type or threaded connector, and the second connector being the other of the male or the female bayonet-type or threaded connector and
characterised further in that the annular body comprises a lip running about the open end of the annular body, the lip defining a tool notch located there along for accommodating there-through, and limiting the angular displacement of, a custom tool for locking at least one of the connectors against rotation during coupling and decoupling of such connectors.

2. The wheel cover according to claim 1, wherein the annular body is substantially cylindrical or substantially bowl-shaped and, where substantially bowl-shaped, the annular body at least one of curves, tapers, and steps radially inwardly from the open end of the annular body towards the base end thereof, and further wherein either: (i) the outer radial face of the annular body is frictionally engageable with the wheel rim directly; or (ii) the annular body supports one or more resilient mounting clips that radially engage the wheel rim.

3. (canceled)

4. The wheel cover according to claim 2, wherein the lip defines an opening into the annular body, the annular body being sized and shaped to operatively locate the lip, with the wheel mount operatively push fit onto the wheel rim, proximate a tire bead of the wheel such that in the event of tire deflation, the wheel cover is pushed free of the wheel rim through contact between the deflated tire and the annular body thereby to minimise damage to the wheel cover, wheel rim or tire.

5. (canceled)

6. The wheel cover according to claim 4, wherein the annular body defines a primary valve notch for accommodating a valve of the wheel to which the wheel mount is operatively mounted, and further the base plate is disc shaped.

7. (canceled)

8. The wheel cover according to claim 6, wherein the second connector is:
rotatably mounted to the display disc on a bearing; or
fixed on the display disc, with the base plate comprising a mounting post extending axially outwardly from the base plate of the wheel mount toward the open end thereof.

9. (canceled)

10. The wheel cover according to claim 8, wherein the first connector is rotatable on the mounting post about a rotary axis passing concentrically through the base plate, the mounting post, the first connector, the second connector and the display disc, with the first connector being rotatably mountable on the mounting post via a bearing.

11. The wheel cover according to claim 10, wherein the mounting post is integral with the base plate, or mountable thereon via a mounting bore defined centrally on the base plate, the base plate defining a secondary valve notch, being alignable with the primary valve notch of the annular body, to co-operatively accommodate the wheel valve therein.

12. The wheel cover according to claim 11, wherein the mounting post is a bolt comprising, from a head-end thereof: the bearing, a cylindrical spacer about which the first connector is receivable; and a nut for engaging a threaded end of the bolt passing through the mounting bore thereby to fasten the mounting post on the base plate, and further wherein the cylindrical spacer acts as a bush on which the first connector has limited axial movement along, with one end of the spacer tightened against an axial face of an inner race of the bearing and an opposite end thereof tightened against the base plate.

13. (canceled)

14. The wheel cover according to claim 12, wherein the first connector is the female bayonet-type connector having a socket formation defining a plurality of substantially L-shaped or J-shaped connecting slots, the second connector being the male bayonet-type connector having a connecting post with a plurality of pins extending radially outwardly therefrom, with the pins being sized and shaped to ride along the connecting slots, such that the male bayonet-type connector is connectable to or disconnectable from the female bayonet-type connector through a relative axial and twist motion.

15. (canceled)

16. The wheel cover according to claim 14, wherein axial inner faces of the first and second connectors abut against respective opposing axial faces of an outer race of the bearing such that rotational forces are transmittable there-between by friction forces acting at the abutting faces, and further wherein the wheel cover comprises first and second rubber washers, the first rubber washer being sandwiched between the first connector and one of the axial faces of the outer race of the bearing, with the second rubber washer being sandwiched between the second connector and the opposite axial face of the outer race of the bearing, thereby to enhance the friction forces acting at the abutting faces.

17. (canceled)

18. The wheel cover according to claim 16, wherein the display disc is sized and shaped substantially the same as the opening defined by the lip of the annular body, the display disc being mountable axially proximate such lip thereby to restrict access to components stored there-behind, and to the connectors other than by using the custom tool, and further wherein the custom tool is sized and shaped to pass through the tool notch defined in the lip of the annular body, and to engage a locking formation on the first connector to operably lock the first connector against rotation about the rotary axis during at least one of coupling and decoupling of the second connector and consequentially the display disc from the first connector.

19. (canceled)

20. The wheel cover according to claim 18, wherein the custom tool is elongate having a first handle end and a second forked end, with the second forked end comprising a pair of prongs having inner faces spaced from one another sufficiently to accommodate the mounting post, and outer faces adapted to engage the locking formation on the first connector, and further wherein the custom tool is at least one of stepped and substantially Z-shaped, having at least one of a rounded and a tapering handle end adapted for operatively leveraging between the wheel rim and the wheel mount to comprise the wheel cover from the wheel.

21. (canceled)

22. The wheel cover according to claim 20, including a means for visually orientating the display disc with the wheel mount thereby to consequentially align the locking formation of the first connector with the tool notch defined on the wheel mount.

23. The wheel cover according to claim 22, wherein a width dimension of the tool notch is slightly greater than a width dimension of the custom tool so as to enable the custom tool to operatively pass there-through to engage the locking formation of the first connector, the relative width dimension operably limiting rotation of the custom tool and consequentially the first connector through abutment of the custom tool with the tool notch ends for enabling coupling and/or decoupling of the display disc from the first connector, and further wherein the width dimension of the tool notch is between 10% and 50% greater than the width dimension of the custom tool.

24. The wheel cover according to claim 23, wherein the display disc comprises one or more of:
secondary counter-weights to balance the display disc thereby to restrict wobble;
an electronic screen for displaying the branding, decorative or advertising indicia thereon; and
lighting thereon to further draw the attention of an onlooker to the branding, decorative or advertising indicia displayed on the display disc;
characterised in that one or more of the electronic screen and lighting is powered by:
an independent power source at least partially located on the wheel cover, with the independent power source and accompanying electronics being mountable on the display disc to also act as the weight; or
the power source of a vehicle to which wheels the wheel cover is operatively mounted, with the power being transmittable between the vehicle and the wheel cover by a conductor or via induction;
characterized further in that the at least one of the electronic screen and lighting is programmable via hardwire or a wireless communications module.

25-28. (canceled)
